(19) United States
(12) Patent Application Publication
(10) Pub. No.: US 2025/0102759 A1
(43) Pub. Date: Mar. 27, 2025

(54) DRIVING MECHANISM

(71) Applicant: TDK TAIWAN CORP., Taoyuan City (TW)

(72) Inventors: Ying-Jen WANG, Taoyuan City (TW); Yi-Ho CHEN, Taoyuan City (TW); Ya-Hsiu WU, Taoyuan City (TW)

(21) Appl. No.: 18/896,304

(22) Filed: Sep. 25, 2024

Related U.S. Application Data
(60) Provisional application No. 63/584,983, filed on Sep. 25, 2023.

(51) Int. Cl. G02B 7/02; H02K 41/035

(52) U.S. Cl. CPC G02B 7/02; H02K 41/0354

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured for moving the optical element relative to the fixed part.

### CROSS REFERENCE TO RELATED APPLICATIONS

This application claims the benefit of U.S. provisional application No. 63/584,983, filed Sep. 25, 2023, the entirety of which is incorporated by reference herein.

### BACKGROUND OF THE INVENTION

### Field of the Invention

The present invention relates to a driving mechanism, and, in particular, it relates to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Electronic devices usually use several coils and magnets for adjusting the focus of a lens. However, miniaturization of these electronic devices may increase the difficulty of mechanical design, and it may also lead to low reliability and a low positioning accuracy of the driving mechanism. It has been a challenge to address this problem.

### BRIEF SUMMARY OF THE INVENTION

An embodiment of the present invention provides a driving mechanism for moving an optical element. The driving mechanism includes a fixed part, a movable part, and a driving assembly. The movable part is movably connected to the fixed part for holding the optical element. The driving assembly is configured for moving the optical element relative to the fixed part.

In some embodiments, the driving mechanism further includes a first electronic element, a circuit structure, and a wire. The movable part has a first member and a second member connected to each other, and the driving assembly includes a vertical coil. The first electronic element and the circuit structure are disposed on the first member, the vertical coil and the wire are disposed on the second member, and the wire is electrically connected between the vertical coil and the circuit structure.

### BRIEF DESCRIPTION OF THE DRAWINGS

The present invention can be more fully understood by reading the subsequent detailed description and examples with references made to the accompanying drawings, wherein:

FIG. 1 is an exploded diagram of a driving mechanism 100 in accordance with an embodiment of the invention.

FIG. 2 is another exploded diagram of the driving mechanism 100 in FIG. 1.

FIG. 3 is a perspective diagram of the driving mechanism 100 in FIGS. 1 and 2 after assembly.

FIG. 4 is an exploded diagram of the driving mechanism 100 with the housing H, the base B, and the flexible circuit board P omitted therefrom.

FIG. 5 is a perspective diagram of the driving mechanism 100 in FIG. 3 with the housing H, the base B, and the flexible circuit board P omitted therefrom.

FIG. 6 is a perspective diagram showing the relative position of the base B, and the flexible circuit board P, and the first and second magnetic elements M1 and M2 of the driving mechanism 100.

FIG. 7 shows an exploded view of the flexible circuit board P and the base B before assembly.

FIG. 8 shows another exploded view of the flexible circuit board P and the base B before assembly.

FIG. 9 shows the relative position of the first and second coils PC1, PC2 and the position sensor HS.

FIG. 10 shows the position sensor HS that is offset from the center of magnetic element M1 along the Z axis.

FIG. 11 shows a cross-sectional view of the driving mechanism 100 with the housing H removed therefrom.

FIG. 12 shows another cross-sectional view of the driving mechanism 100 with the housing H removed therefrom.

FIG. 13 shows a schematic diagram of the conductive element K connected between the inner surface P11 of the main body P1 of the flexible circuit board P and the lateral surface PC3 of the circuit substrate PC.

FIG. 14 shows a schematic diagram of the adhesive element G connected between the flexible circuit board P and the protruding structure B1 of the base B.

FIG. 15 shows an exploded diagram of the first and second electronic elements E1 and E2, a circuit board E3, a plurality of metal pieces E4, and the first and second members LH1 and LH2 of the holder LH before assembly.

FIG. 16 shows an exploded view of the resilient elements S and the holder LH before assembly.

FIG. 17 shows a schematic diagram of the resilient elements S connecting the holder LH and the frame F.

FIG. 18 shows a schematic diagram of the cavity F11 formed on the frame F in FIG. 17.

FIG. 19 shows a schematic diagram of two wires RC1 and a connecting wire RC2 disposed on the bottom side of the second member LH2.

FIG. 20 shows a schematic diagram of the wires RC1 and the connecting wire RC2 electrically connected to the vertical coils C1 and the conductive pads PD3 of the metal pieces E4.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

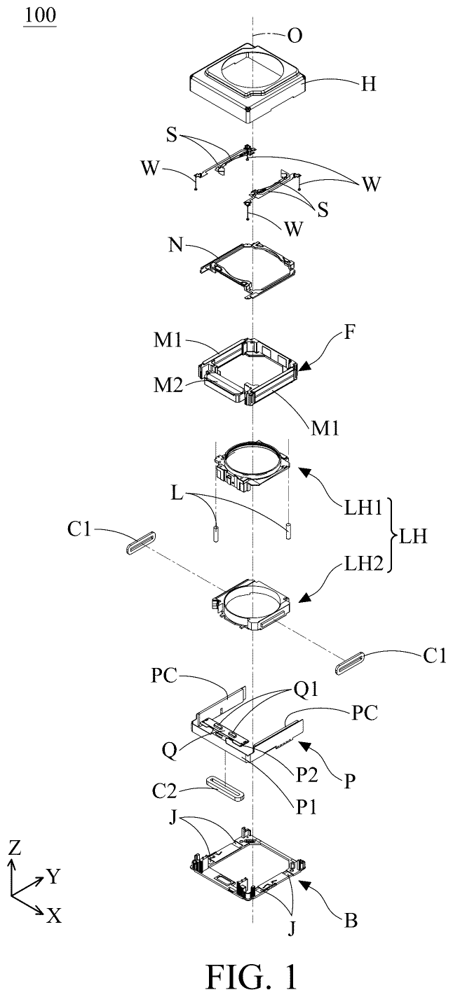

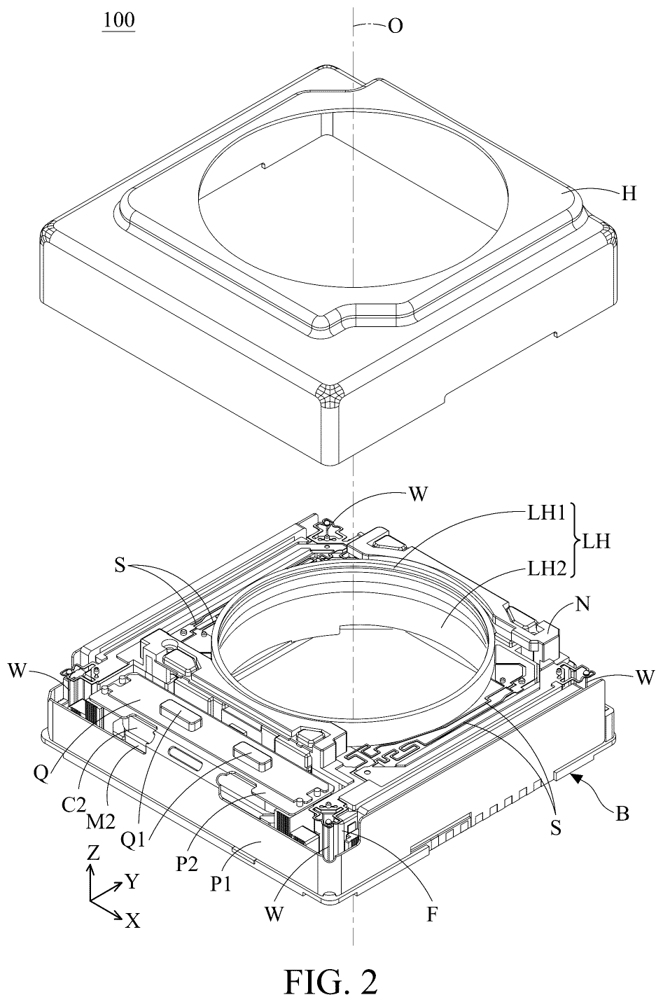

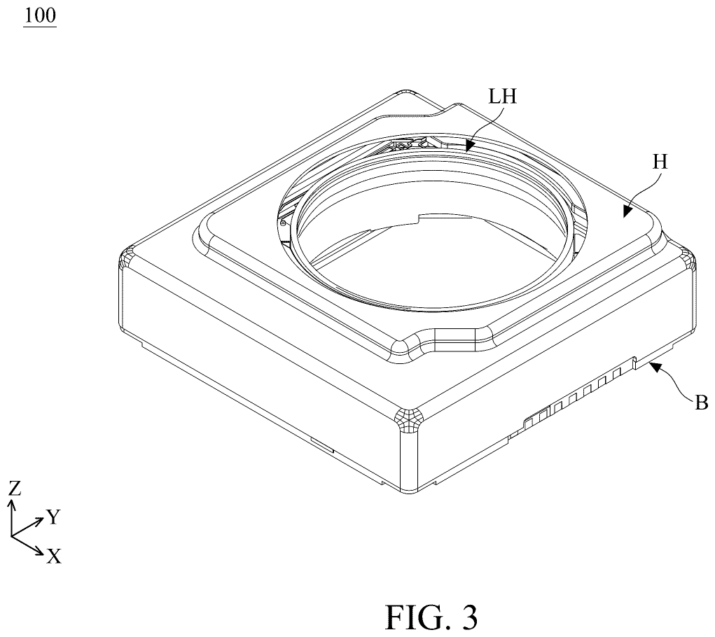

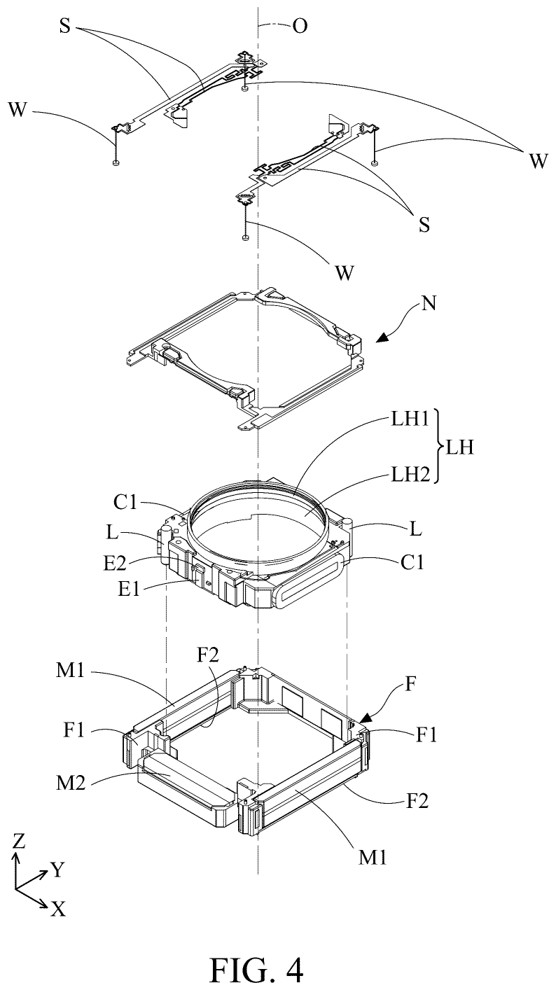

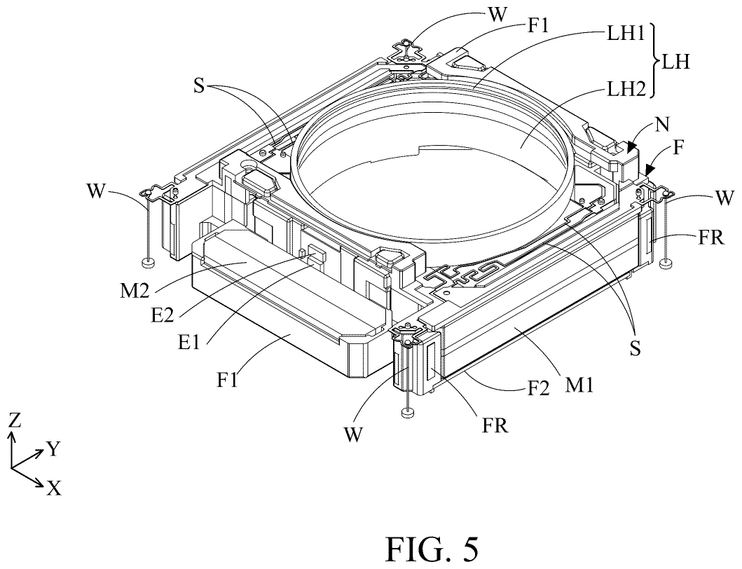

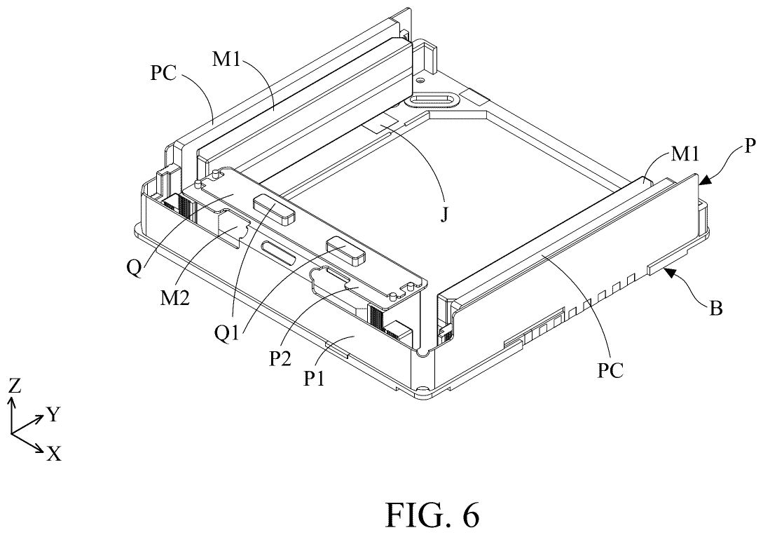

FIG. 1 is an exploded diagram of a driving mechanism 100 in accordance with an embodiment of the invention. FIG. 2 is another exploded diagram of the driving mechanism 100 in FIG. 1. FIG. 3 is a perspective diagram of the driving mechanism 100 in FIGS. 1 and 2 after assembly. FIG. 4 is an exploded diagram of the driving mechanism 100 with the housing H, the base B, and the flexible circuit board P omitted therefrom. FIG. 5 is a perspective diagram of the driving mechanism 100 in FIG. 3 with the housing H, the base B, and the flexible circuit board P omitted therefrom. FIG. 6 is a perspective diagram showing the relative position of the base B, and the flexible circuit board P, and the first and second magnetic elements M1 and M2 of the driving mechanism 100.

Referring to FIGS. 1-6, the driving mechanism 100 is a Voice Coil Motor (VCM) which may be disposed in a cell phone or other portable electronic device for driving an optical element (e.g. optical lens) to move, thereby achieving the function of auto-focusing (AF) or Optical Image stabilization (OIS).

The driving mechanism 100 primarily comprises a hollow housing H, a base B, a flexible circuit board P, a holder LH, a frame F, a clamping member N, a plurality of resilient elements S, and a plurality of metal wires W. In this embodiment, the flexible circuit board P is adhered to the base B. The housing H has a hollow structure affixed to the base B, thus forming a fixed part of the driving mechanism 100.

The holder LH and the frame F are movably received in the housing H, wherein the holder LH is configured for holding an optical element (not shown). Here, the holder LH and the frame F constitute a movable part of the driving mechanism 100 that can move relative to the fixed part (the housing H and the base B).

In this embodiment, the resilient elements S are connected between the holder LH and the frame F. The metal wires W extend along the Z axis and are connected between the resilient elements S and the base B.

With the configuration as described above, external light can enter the driving mechanism 100 substantially along the optical axis O (Z axis) of the optical element, and light can propagate through the optical element to an image sensor (not shown) below the base B to form a digital image.

It should be noted that the holder LH has a first member LH1 and a second member LH2 affixed to each other. Two vertical coils C1 are disposed on opposite sides of the holder LH, and two first magnetic elements M1 (e.g. magnets) are disposed on opposite sides of the frame F, corresponding to the vertical coils C1.

When a current signal is applied to the vertical coils C1, an electromagnetic force can be generated by the vertical coils C1 and the first magnetic elements M1, so that the holder LH and the optical element received therein are driven to move relative to the frame F along the optical axis O (Z axis) to achieve the function of auto-focusing (AF) or optical Image stabilization (OIS).

In this embodiment, the clamping member N is affixed to the top side of the frame F. Two rods L are clamped between the holder LH and the clamping member N. The holder LH can stably slide relative to the frame F along the rods L which are parallel to the optical axis O and the Z axis.

The flexible circuit board P has a C-shaped main body P1 and a bent portion P2 bent relative to the main body P1. A horizontal coil C2 is disposed beneath the bent portion P2, and a second magnetic element M2 (e.g. magnet) is disposed on the frame F and adjacent to the horizontal coil C2. The horizontal coil C2 is electrically connected to the bent portion P2 of the flexible circuit board P. The horizontal coil C2 and the second magnetic element M2 are arranged along the Z axis, and the long axis of the horizontal coil C2 is perpendicular to the optical axis O (Z axis).

In addition, a metal member Q and at least a positioning post Q1 are disposed on the bent portion P2 of the flexible circuit board P. Two positioning posts Q1 extend through the metal member Q, the bent portion P2, and the horizontal coil C2. Therefore, the horizontal coil C2 can be precisely positioned on the bent portion P2. In this embodiment, the horizontal coil C2 comprises an enameled wire.

When a current signal is applied to the horizontal coil C2, an electromagnetic force can be generated by the horizontal coil C2 and the second magnetic element M2, so that the holder LH and the frame F are driven to move relative to the base B along a first axis (Y axis) to achieve the function of auto-focusing (AF) or optical Image stabilization (OIS).

It can be seen in FIGS. 1 and 6 that two circuit substrates PC are disposed on opposite sides of the main body P1 of the flexible circuit board P. The circuit substrates PC are not parallel to the bent portion P2 of the flexible circuit board P, and the thickness of the flexible circuit board P is less than the thickness of the circuit substrates PC.

In this embodiment, a plurality of coils are disposed inside the circuit substrates PC and located adjacent to the first magnetic element M1. When a current signal is applied to the coils inside the circuit substrates PC, an electromagnetic force can be generated by the coils and the first magnetic element M1, so that the holder LH and the frame F are driven to move relative to the base B along a second axis (X axis) to achieve the function of auto-focusing (AF) or optical Image stabilization (OIS).

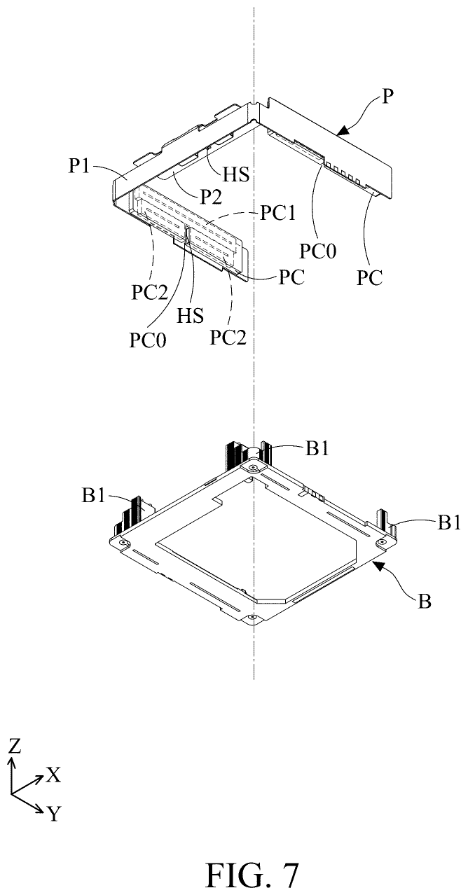

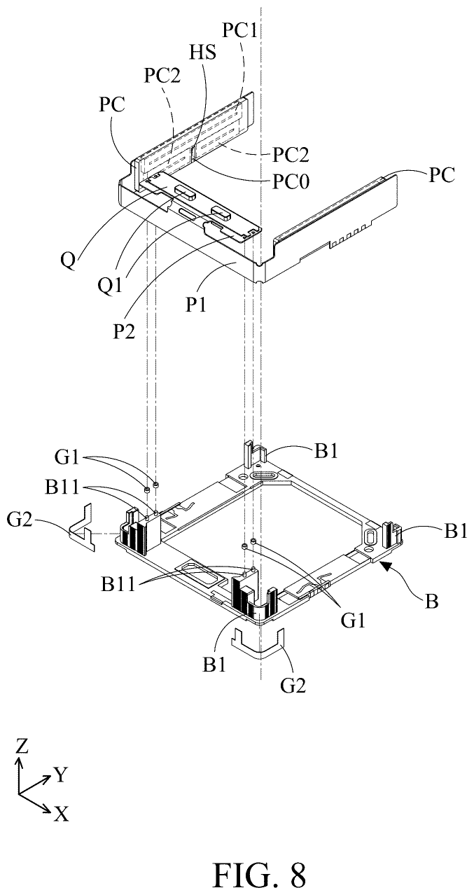

The vertical coils C1, the horizontal coils C2, the first and second magnetic elements M1 and M2, and the first and second coils C1 and C2 (FIGS. 7 and 8) inside the circuit substrates PC constitute a driving assembly of the driving mechanism 100 for driving the holder LH to move relative to the frame F, or driving the movable part (the holder LH and the frame F) to move relative to the fixed part (the base B and the housing H).

Moreover, as shown in FIGS. 1 and 4, a first electronic element E1 and a second electronic element E2 are disposed on the first member LH1 of the holder LH. The first electronic element E1 may be a Hall effect sensor for detecting the displacement of the second magnetic element M2 (e.g. magnet) disposed on the frame F. The second electronic element E2 may comprise an integrated circuit member, such as a control IC that is electrically connected to the first electronic element E1.

The frame F has two plastic bodies F1 and a U-shaped metal bracket F2 (FIG. 4) affixed to each other. The first magnetic element M1 is disposed on the metal bracket F2 and positioned between the two plastic bodies F1.

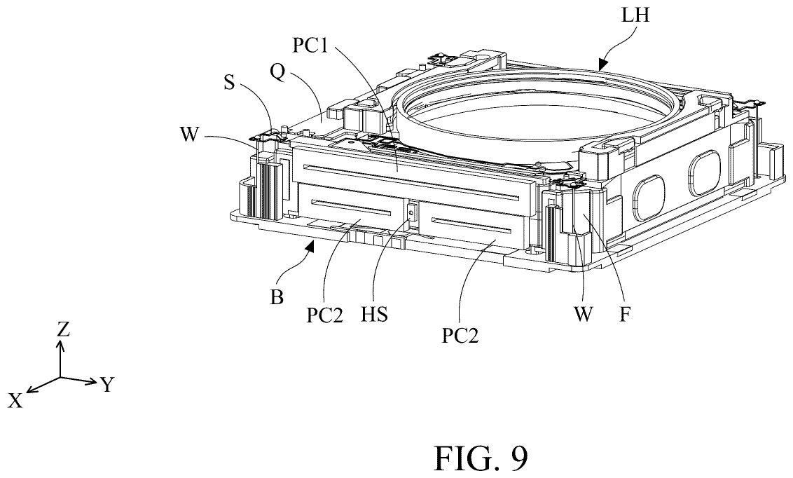

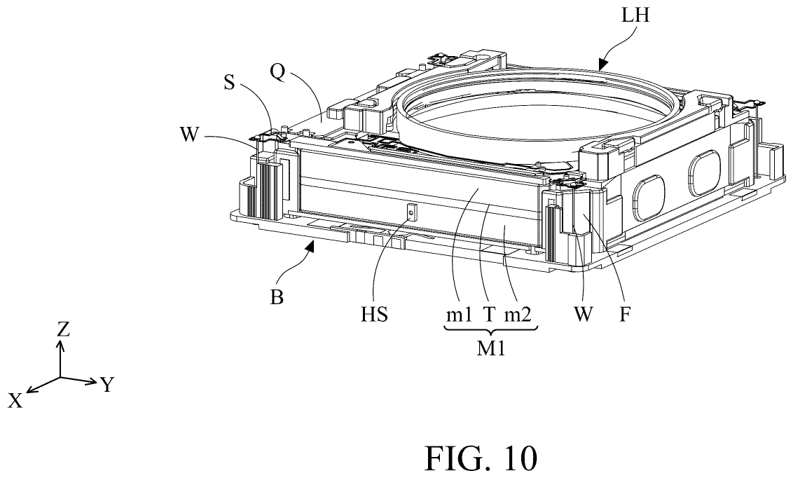

FIG. 7 shows an exploded view of the flexible circuit board P and the base B before assembly. FIG. 8 shows another exploded view of the flexible circuit board P and the base B before assembly. FIG. 9 shows the relative position of the first and second coils PC1, PC2 and the position sensor HS. FIG. 10 shows the position sensor HS that is offset from the center of magnetic element M1 along the Z axis.

As shown in FIGS. 7, 8, 9, and 10, the base B of this embodiment forms four protruding structures B1 that extend along the optical axis O (Z direction). At least one of the protruding structures B1 forms at least one positioning pin B11 (FIG. 8) extending through the bent portion P2 along the Z axis.

Specifically, a first coil PC1 and two second coils PC2 are disposed inside the circuit substrate PC and arranged along the Z axis. The first and second coils PC1 and PC2 (e.g. planar coils) are electrically connected to the flexible circuit board P and located adjacent to the first magnetic element M1, and they at least partially overlap along the Z axis.

The length of the first coil PC1 along the Y axis is greater than the length of the second coils PC2 along the Y axis. Moreover, a position sensor HS (e.g. Hall effect sensor) is provided on the flexible circuit board P and accommodated in a groove PC0 of the circuit substrate PC. The position sensor HS is located between the two second coils PC2 to detect the displacement of the movable part relative to the fixed part along the X axis.

It should be noted that the position sensor HS is lower than the center of the first magnetic element M1 in the Z axis. Here, the position sensor HS and the first magnetic element M1 at least partially overlap along the X axis, and the position sensor HS and the second coil PC2 at least partially overlap along the Y axis.

In this embodiment, the second coils PC2 do not protrude from the first coil PC1 along the Y axis. The position sensor HS and the first coil PC1 do not overlap along the Y axis. Moreover, the position sensor HS and the first coil PC1 at least partially overlap along the Z axis, and the position sensor HS and the second coil PC2 do not overlap along the Z axis.

It can be seen in FIG. 10 that the first magnetic element M1 includes a first magnetic unit m1 and a second magnetic unit m2 arranged along the Z axis. The first magnetic unit m1 and the first coil PC1 at least partially overlap along the X axis, and the second magnetic unit m2 and the second coil PC2 at least partially overlap along the X axis.

Moreover, the second magnetic unit m2 and the position sensor HS at least partially overlap along the X axis. The first magnetic unit m1 and the position sensor HS do not overlap along the X axis.

In this embodiment, the long axis of the first magnetic element M1 is parallel to the Y axis (the first axis). The circuit substrate PC and the first magnetic element M1 are spaced apart from each other along the X axis (the second axis).

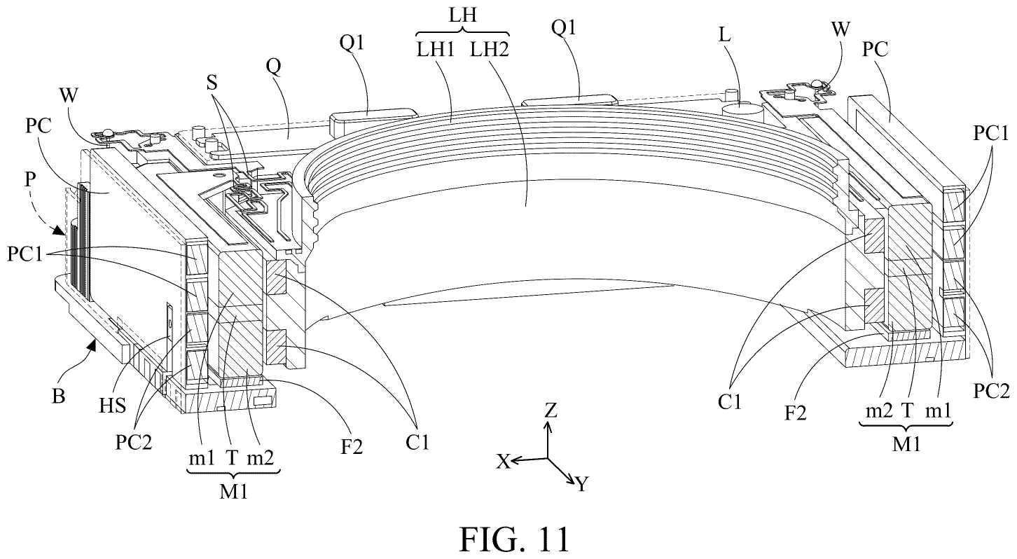

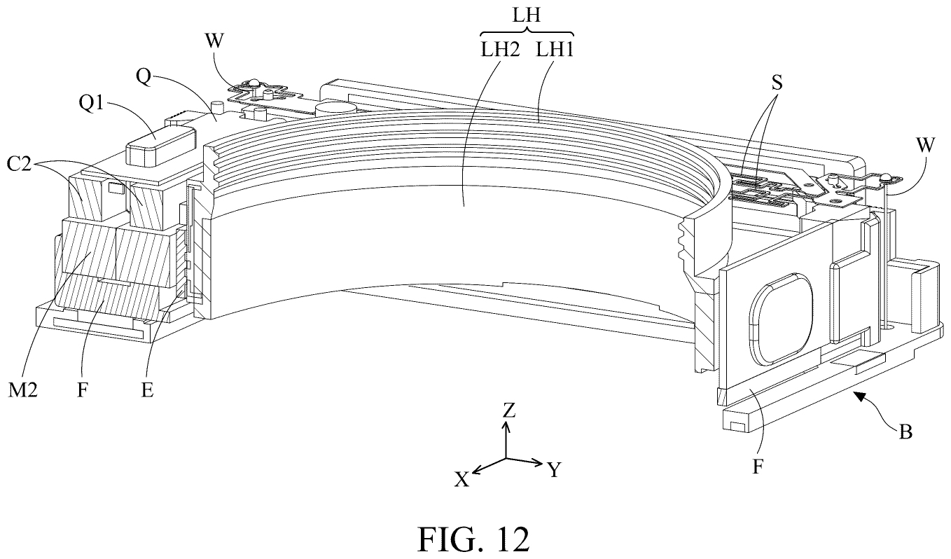

FIG. 11 shows a cross-sectional view of the driving mechanism 100 with the housing H removed therefrom. FIG. 12 shows another cross-sectional view of the driving mechanism 100 with the housing H removed therefrom.

Referring to FIG. 11, a metal sheet T is disposed between the first magnetic unit m1 and the second magnetic unit m2, wherein the polar directions of the first magnetic unit m1 and the second magnetic unit m2 are different.

It should be noted that at least one magnetic permeable sheet J is disposed on the base B, as shown in FIG. 1. A magnetic attraction force can be generated between the magnetic permeable sheet J and the first magnetic element M1, so that the frame F is stably held above base B.

In this embodiment, the magnetic permeability of the magnetic permeable sheet J is higher than the magnetic permeability of the metal sheet T, wherein the second magnetic unit m2 is located between the metal sheet T and the magnetic permeable sheet J after assembly.

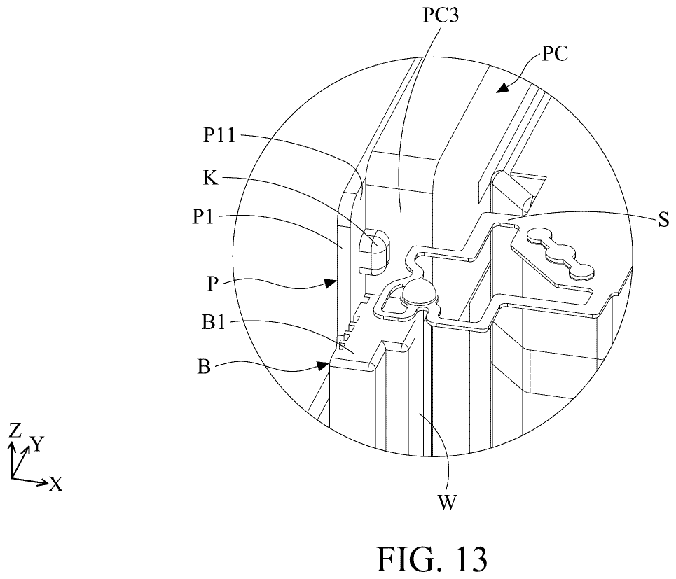

FIG. 13 shows a schematic diagram of the conductive element K connected between the inner surface P11 of the main body P1 of the flexible circuit board P and the lateral surface PC3 of the circuit substrate PC.

As shown in FIG. 13, a conductive element K (e.g. solder) is applied to the inner surface P11 of the main body P1 of the flexible circuit board P and the lateral surface PC3 of the circuit substrate PC, thus electrically connecting the flexible circuit board P to the circuit substrate PC. In this embodiment, the inner surface P11 faces the circuit substrate PC, and the lateral surface PC3 is adjacent to the inner surface P11.

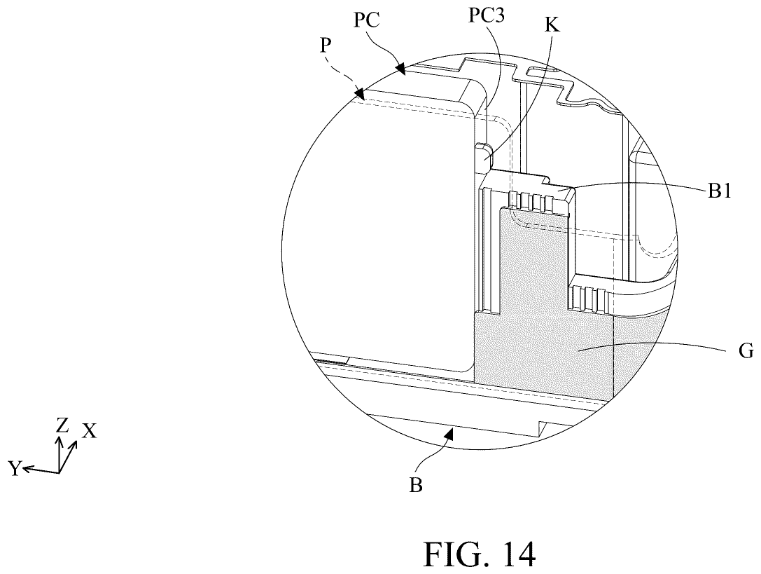

FIG. 14 shows a schematic diagram of the adhesive element G connected between the flexible circuit board P and the protruding structure B1 of the base B.

As shown in FIGS. 8 and 14, the base B has four protruding structures B1 extending in the Z direction. Two adhesive elements G (e.g. glue) are respectively applied to two of the protruding structures B1 (FIG. 8). Hence, the flexible circuit board P can be firmly connected to the base B, wherein the protruding structure B1 and the circuit substrate PC do not overlap along the X axis. In this embodiment, the adhesive element G is in contact with the circuit substrate PC, the protruding structure B1, and the flexible circuit board P (FIG. 14), whereby they can be firmly adhered to each other.

It can be seen in FIG. 5 that at least one buffer element FR (e.g. rubber or soft plastic bump) is disposed on the plastic body F1 of the frame F. When the movable part moves to a limit position relative to the fixed part along the X axis, the buffer element FR contacts the circuit substrate PC to prevent the first magnetic element M1 from being impacted by the circuit substrate PC.

In this embodiment, the hardness of the buffer element FR is smaller than the hardness of the base B and the plastic body F1 of the frame F. In addition, the hardness of the plastic body F1 is smaller than the hardness of the base B.

As shown in FIG. 12, the positioning post Q1 extends through the horizontal coil C2, and the distance between the positioning post Q1 and the second magnetic element M2 is smaller than the distance between the horizontal coil C2 and the second magnetic element M2. Hence, when the frame F moves relative to the base B in the Z direction, the positioning post Q1 can contact the second magnetic element M2, thereby preventing the second magnetic element M2 from direct collision with the horizontal coil C2.

In this embodiment, the top end of the positioning post Q1 may be adhered to the housing H during assembly, thus improving the structural strength and reliability of the driving mechanism 100.

It can be seen from FIG. 8 that the bent portion P2 of the flexible circuit board P can be adhered to the top surface of the protruding structure B1 through the first adhesive G1, and the main body P1 of the flexible circuit board P can be adhered to the outer surface of the protruding structure B1 through the second adhesive G2, wherein the first and second adhesives G1 and G2 are separated from each other.

With the configuration of the driving mechanism 100, the first magnetic element M1 can be used as a common magnetic element for the holder LH and the frame F, thereby reducing the size of the driving mechanism 100 and achieving the function of auto-focusing (AF) or Optical Image stabilization (OIS). Moreover, with the first electronic element E1 positioned corresponding to the second magnetic element M2, the number of the sensing magnets can be reduced, so as to achieve miniaturization and lightweight of the driving mechanism 100. Additionally, with the position sensor HS positioned between the second coils PC2, crosstalk errors caused by rotation of the movable part relative to the fixed part can be efficiently suppressed, thereby improving sensing accuracy of the driving mechanism 100.

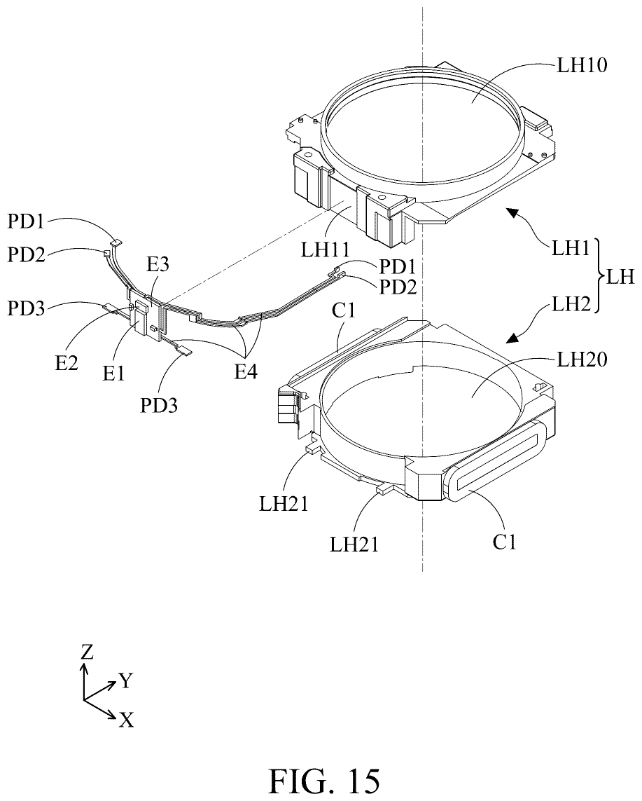

FIG. 15 shows an exploded diagram of the first and second electronic elements E1 and E2, a circuit board E3, a plurality of metal pieces E4, and the first and second members LH1 and LH2 of the holder LH before assembly.

As shown in FIG. 15, the first and second electronic elements E1 and E2 (e.g. integrated circuit elements) are disposed on a circuit board E3. When viewed along the Z axis, the first and second electronic elements E1 and E2 at least partially overlap.

In this embodiment, both of the first and second electronic elements E1 and E2 have a longitudinal structure, wherein the long axes of the first and second electronic elements E1 and E2 are perpendicular to each other. Moreover, a recess LH11 is formed on a lateral side the first member LH1, wherein the first and second electronic elements E1 and E2 and the circuit board E3 are received in the recess LH11.

It should be noted that a plurality of metal pieces E4 form a circuit structure that may be embedded in the first member LH1 of the holder LH by insert molding. Specifically, some of the metal pieces E4 are used to electrically connect the resilient elements S to the circuit board E3, and some of the metal piece E4 are used to electrically connect the vertical coil C1 to the circuit board E3.

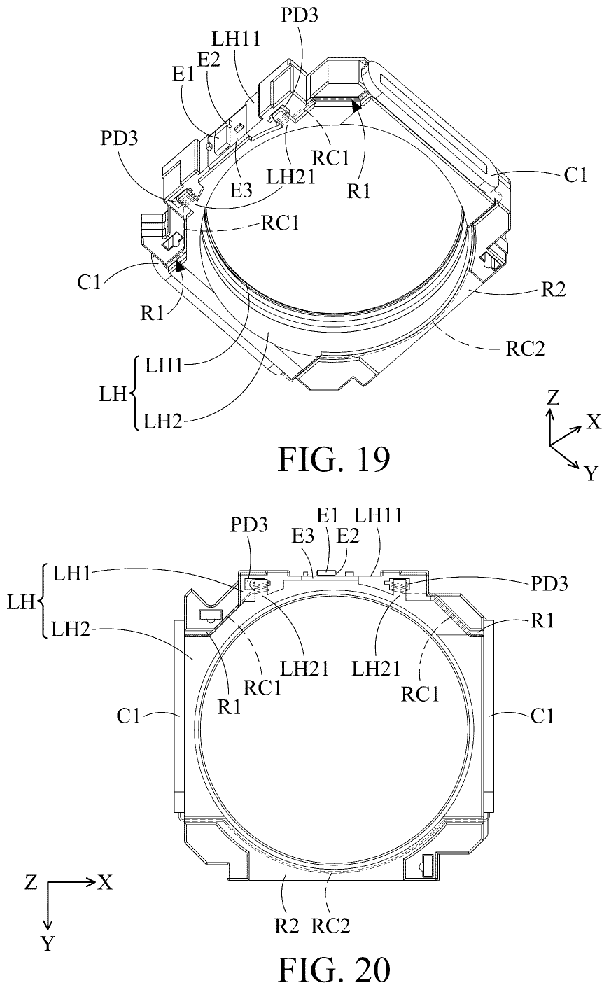

In this embodiment, two winding posts LH21 are formed on the same side of the second member LH2 of the holder LH. An end of the wires RC1 (FIGS. 19 and 20) can be electrically connected to the vertical coils C1 on the second member LH2, and the other end of the wires RC1 can be wound around the winding post LH21 and connected to the metal piece E4 (circuit structure).

In some embodiments, the metal piece E4 may be replaced by a flexible circuit board (FPC), which is not limited to what is disclosed in the embodiment of the present invention.

It can be seen in FIG. 15 that a first through hole LH10 is formed at the center of the polygonal first member LH1, and a second through hole LH20 is formed at the center of the polygonal second member LH2 for accommodating the optical elements. When viewed along the Z axis, the first through hole LH10 is smaller than the second through hole LH20.

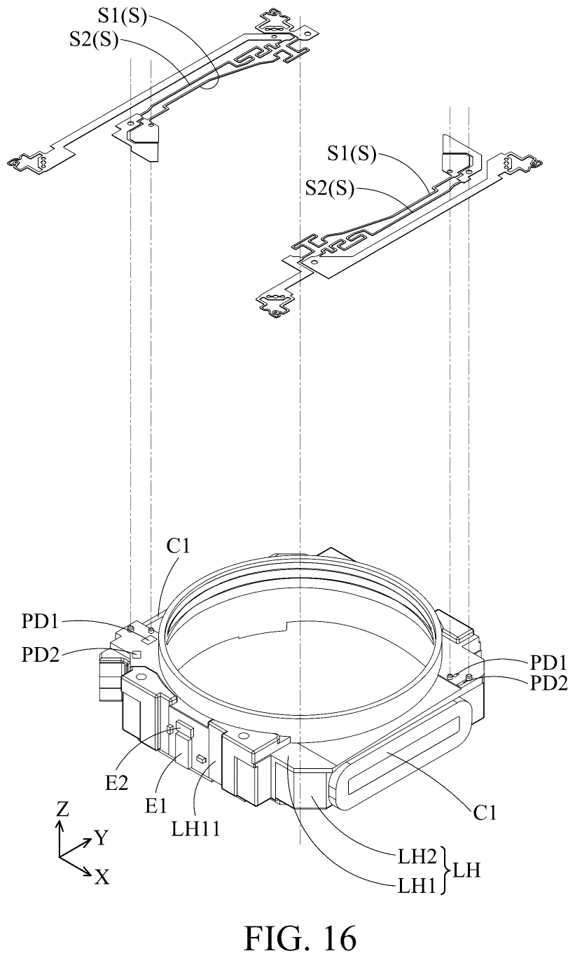

FIG. 16 shows an exploded view of the resilient elements S and the holder LH before assembly.

Referring to FIGS. 15 and 16, two resilient elements S are located on the same side of the holder LH. The resilient elements S have elongated resilient structures S1 and S2 (FIG. 16) which are located adjacent to and parallel to each other. Some of the metal pieces E4 can electrically be connected to the resilient element S through the conductive pads PD1 and PD2, and the other metal pieces E4 can be electrically connected to the wire RC1 through the conductive pads PD3 (FIG. 15) from the bottom side of the holder LH. It should be noted that a part of the wire RC1 is wound and fixed on the winding post LH21 (FIGS. 19 and 20), and the conductive pads PD3 is located close to the winding post LH21, and. Hence, the metal pieces E4 can be electrically connected to the vertical coils C1 through the wires RC1.

In some embodiments, a damping element (such as gel) can be applied to the resilient structures S1 and S2, whereby the resilient structures S1 and S2 can be movably connected to each other through the damping element to improve stability and reliability of the driving mechanism 100.

In some embodiments, the conductive pads PD1 and PD2 may be electrically connected to the resilient elements S by soldering, welding or conductive glue, and the resilient elements S can be sandwiched between the conductive pads PD1, PD2 of the metal pieces E4 and an external circuit (e.g. aperture circuit, a shutter circuit or other circuit elements) along the Z axis.

For example, the resilient elements S may be spring sheets that comprise titanium alloy, and the metal pieces E4 may comprise copper alloy that is different from the resilient elements S.

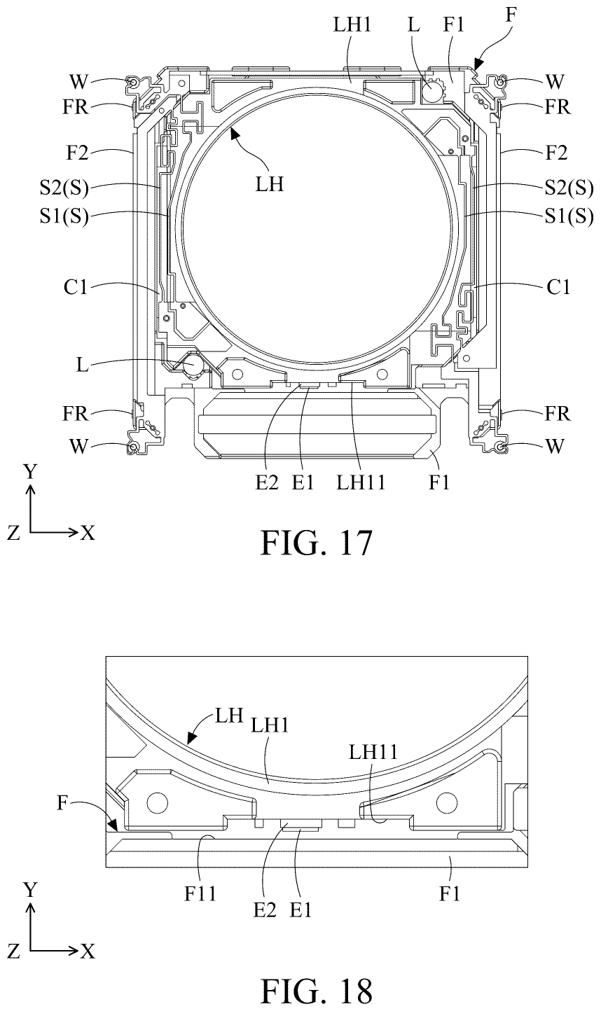

FIG. 17 shows a schematic diagram of the resilient elements S connecting the holder LH and the frame F. FIG. 18 shows a schematic diagram of the cavity F11 formed on the frame F in FIG. 17.

Referring to FIGS. 17 and 18, when viewed along the Z axis, a plurality of resilient elements S are arranged on the opposite side of the holder LH to movably connect the holder LH with the frame F. Additionally, four thin metal wires W electrically connect the resilient elements S to the conductive terminals (not shown) on the base B along the Z axis.

In this embodiment, the first and second electronic elements E1 and E2 are disposed in the recess LH11 of the holder LH, facing the cavity F11 on the plastic body F1 of the frame F. Specifically, the depth of the recess LH11 may be less than the thickness of the first and second electronic elements E1 and E2. In this configuration, at least a part of the first electronic element E1 or the second electronic element E2 can enter the cavity F11 of the plastic body F1 when the first member LH1 of the holder LH moves in the −Y direction and contacts the plastic body F1. Therefore, the first and second electronic elements E1 and E2 can be prevented from direct collision with the plastic body F1.

FIG. 19 shows a schematic diagram of two wires RC1 and a connecting wire RC2 disposed on the bottom side of the second member LH2. FIG. 20 shows a schematic diagram of the wires RC1 and the connecting wire RC2 electrically connected to the vertical coils C1 and the conductive pads PD3 of the metal pieces E4.

Referring to FIGS. 19 and 20, the driving mechanism 100 in this embodiment further includes two wires RC1 and a connecting wire RC2. The wires RC1 are accommodated in the grooves R1 on the bottom side of the second member LH2 to electrical connect the conductive pads PD3 with the vertical coils C1 and the conductive pads PD3 of the metal pieces E4. In this embodiment, each of the conductive pads PD3 is located close to the winding post LH21, and a part of the wire RC1 is located between the winding post LH21 and the conductive pad PD3 along the Z axis.

Moreover, the connecting wire RC2 is accommodated in the depressed structure R2 on the bottom side of the second member LH2 to electrically connect the vertical coils C1 which are disposed on opposite sides of the holder LH.

With the configuration of the embodiment, the vertical coils C1 can be electrically connected to the first and second electronic elements E1 and E2 on the circuit board E3 through the wires RC1, the connecting wire RC2, and the metal pieces E4. Hence, a circuit loop can be formed between the vertical coils C1 and the first and second electronic elements E1 and E2.

It should be noted that the bottom surfaces of the grooves R1 and the depressed structure R2 are coplanar (situated on the same plane that is perpendicular to the Z axis). Moreover, the position of the conductive pads PD3 in the Z direction is between the grooves R1 (or the depressed structure R2) and the winding posts LH21. Thus, the thickness of the holder LH along the Z axis can be efficiently reduced, and miniaturization of the driving mechanism 100 can also be achieved.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element that has an optical axis, comprising:
a fixed part;
a movable part, movably connected to the fixed part for holding the optical element, wherein the optical element has an optical axis; and
a driving assembly, configured for moving the movable part relative to the fixed part.

2. The driving mechanism as claimed in claim 1, further comprising a first electronic element, a circuit structure, and a wire, wherein the movable part has a first member and a second member connected to each other, and the driving assembly includes a vertical coil, wherein the first electronic element and the circuit structure are disposed on the first member, the vertical coil and the wire are disposed on the second member, and the wire is electrically connected between the vertical coil and the circuit structure.

3. The driving mechanism as claimed in claim 2, wherein the first member forms a recess for receiving the first electronic element, and the depth of the recess is less than the thickness of the first electronic element.

4. The driving mechanism as claimed in claim 2, further comprising a second electronic element disposed on the first member, wherein when viewed along the optical axis, the first and second electronic elements at least partially overlap.

5. The driving mechanism as claimed in claim 4, wherein first and second electronic elements are integrated circuit elements, and the circuit structure is embedded in the first member and electrically connected to the first and second electronic elements.

6. The driving mechanism as claimed in claim 4, wherein both of the first and second electronic elements have a longitudinal structure, and the long axes of the first and second electronic elements are not parallel to each other.

7. The driving mechanism as claimed in claim 2, further comprising a resilient element, wherein the movable part further has a frame, the driving assembly includes a first magnetic element disposed on the frame and located adjacent to the vertical coil, and the resilient element is disposed on the first member and connected to the frame.

8. The driving mechanism as claimed in claim 7, wherein the frame forms a cavity, and at least a part of the first electronic element is received in the cavity when the first member contacts the frame.

9. The driving mechanism as claimed in claim 7, wherein the resilient element is electrically connected to the circuit structure, and the resilient element and the circuit structure comprise different material.

10. The driving mechanism as claimed in claim 7, wherein the resilient element is sandwiched between the circuit structure and an external circuit.

11. The driving mechanism as claimed in claim 7, further comprising a metal wire electrically connected between the resilient elements and a conductive terminal of the fixed part.

12. The driving mechanism as claimed in claim 7, further comprising a rod and a hollow clamping member, wherein the rod and the clamping member are affixed to the frame, the first and second members constitute a holder for holding the optical element, and the rod is held between the holder and the clamping member.

13. The driving mechanism as claimed in claim 7, further comprising two resilient elements, wherein the first and second members constitute a polygonal holder for holding the optical element, and the resilient elements are disposed on the same side of the holder to movably connect the holder with the frame.

14. The driving mechanism as claimed in claim 13, wherein both of the resilient elements have an elongated resilient structure, and the resilient structures are located adjacent to and parallel to each other.

15. The driving mechanism as claimed in claim 14, further comprising a damping element connected between the resilient structures.

16. The driving mechanism as claimed in claim 2, wherein the first member forms a first through hole, the second member forms a second through hole, and the first through hole is small than the second through hole when viewed along the optical axis.

17. The driving mechanism as claimed in claim 2, wherein the second member has a polygonal structure and forms a winding post, and the circuit structure has a conductive pad exposed to the second member and located adjacent to the winding post, wherein at least a part of the wire is located between the conductive pad and the winding post.

18. The driving mechanism as claimed in claim 17, wherein the second member forms a groove for receiving the wire, and the conductive pad is located between the winding post and the groove along the optical axis.

19. The driving mechanism as claimed in claim 18, further comprising two wires, wherein the second member further forms two winding posts and two grooves, and the driving assembly further includes two vertical coils electrically connected to the circuit structure via the wires, wherein the winding posts are located on the same side of the second member when viewed along the optical axis.

20. The driving mechanism as claimed in claim 19, further comprising a connecting wire electrically connected between the vertical coils, wherein the second member further forms a depressed structure for receiving the connecting wire, and the bottom surfaces of the grooves and the bottom surface of the depressed structure are situated on the same plane that is perpendicular to the optical axis.
